(19) United States
(12) Patent Application Publication
(10) Pub. No.: US 2025/0200277 A1
(43) Pub. Date: Jun. 19, 2025

(54) METHODS AND SYSTEMS FOR QUANTIZATION OF LARGE LANGUAGE MODELS

(71) Applicant: HUAWEI TECHNOLOGIES CO., LTD., Shenzhen (CN)

(72) Inventors: Seyed Alireza GHAFFARI, Brossard (CA); Sharareh YOUNESIAN, Montreal (CA); Masoud ASGHARIAN, Kanata (CA); Boxing CHEN, Ottawa (CA); Vahid PARTOVI NIA, Brossard (CA)

(21) Appl. No.: 18/545,360

(22) Filed: Dec. 19, 2023

(51) Int. Cl. G06F 40/20; G06F 7/499

(52) U.S. Cl. CPC G06F 40/20; G06F 7/49957

(57) ABSTRACT

A method and an apparatus for storing data points are provided. The method comprises: receiving the plurality of data points, each data point of the plurality of data points being represented in a floating-point representation; quantizing each one of the first plurality of data points, by: executing, during a first quantization phase: converting each data point of the plurality of data points into a corresponding first data point of a plurality of first data points; executing, during a second quantization phase: applying, to each first data point of the plurality of first data points a clamping function, thereby converting each first data point of the plurality of first data points into a corresponding second data point of a plurality of second data points; and storing the plurality of second points for further calculations instead of the first plurality of data points.

### FIELD

The present technology relates generally machine learning, and more specifically, to methods and systems for quantization of Large Language Models (LLMs).

### BACKGROUND

Over the past recent years, Large Language Models (LLMs) have revolutionized Natural Language Processing (NLP) tasks, such as machine translation, text generation and question answering. However, the size of these models increases rapidly, and the corresponding computational demand causes significant challenges in terms of memory requirement and energy consumption both during training and inference stages.

Some quantization techniques have been proposed for reducing memory consumption and increasing speed of inference on LLMs. However, these quantization techniques usually result in reduced precision of model parameters from 16-bit floating-point, to for example 4-bit integers. Preserving the accuracy and quality of a LLM is specially challenging when quantizing to 4-bit or even less.

An article entitled “LLM.int8( ): 8-bit Matrix Multiplication for Transformers at Scale,” authored by Dettmers et al., and published at arxiv.org on Nov. 10, 2022, discloses a method of quantizing language models using mostly 8-bit matrix multiplications. There was observed presence of outliers in activations when the model size gets larger than 6.7B. As such, quantizing both the weights and activations to 8-bit could result in decreased performance quality. Thus, it was suggested to decompose activation and weights in a way that isolates the outliers. Thus, this method may enable to perform the matrix multiplication of outlier in FP16 number format and also INT8 is used for the rest of the values.

An article entitled “OPTQ: Accurate Post-training Quantization For Generative Pre-trained Transformers,” authored by Frantar et al., and published in the proceedings of the International Conference on Learning Representations on the Mar. 1, 2023, attempts to address the problem of finding a matrix of quantized weights that minimizes the squared error with respect to the full precision layer output. There was presented a modification of the optimal brain quantization algorithm including fixing the quantization order of weights. The algorithm was shown to quantize the weights to INT4 and INT3 using a small set of calibration data.

An article entitled “Efficient and Affordable Post-Training Quantization for Large-Scale Transformers,” authored by Yao et al., and published in the proceedings of the 36th Conference on Neural Information Processing Systems on Jun. 4, 2022, discloses a method of applying fine-grained quantization on weights and activations to capture different range of numbers. In the disclosed method, group-wise quantization is applied to weights and token-wise quantization to activations. Further, to evenly quantize the model further, the method includes a layer-by-layer knowledge distillation method to enable int4 weights for linear layers and INT8 weights for multi-head self-attention layers.

An article entitled “SmoothQuant: Accurate and Efficient Post-Training Quantization for Large Language Models,” authored by Xiao et al., and published at arxiv.org on Nov. 18, 2022, discloses quantizing outliers in activations. More specifically, it is suggested migrating the quantization difficulty from activations to the weights. In other words, the activations are smoothed by a scaling factor for each channel and also the weights are scaled in the reverse direction in order to have the same multiplication result.

An article entitled “Efficient Finetuning of Quantized LLMs,” authored by Dettmers et al., and published at arxiv.org on May 23, 2023, discloses 4-bit NormalFloat number format and double quantization to save memory without losing accuracy. Also, the disclosed method includes 4-bit finetuning and using low rank adapters. The NormalFloat datatype is based on quantizing weights to k bins so that there are same number of data in each bin. To find the bins, transformation of the weights to normal distribution is performed by scaling the standard deviation to 1 and calculate the bins based on this distribution.

### SUMMARY

Developers have devised methods and devices for overcoming at least some drawbacks present in prior art solutions.

Developers of the present technology have realized that at least some of the prior art methods reviewed above are based on absmax (or sometime minmax) quantization that maps the inputs to the corresponding n-bit range [−2ⁿ⁻¹−1, 2ⁿ⁻¹−1] by a multiplying scale

$$s = \frac{{2}^{n - 1}}{max ( \vert W \vert )} .$$

The quantized weight is calculated as

$$⌊ \frac{{2}^{n - 1}}{max ( \vert W \vert )} W ⌉ = ⌊ sW ⌉$$

where └ ┐ denotes a given rounding method used in the quantization scheme. In contrast, developers of the present technology have devised a quantization technique in which the number format is modified and where a shared scale is extracted based on maximum exponent of a group of floating-point numbers.

The quantization techniques disclosed in the prior art can only work with 4-bit quantization using a calibration set and do not have good performance in zero-shot quantization. Therefore, there is a considerable drop in accuracy of model when quantizing to 4-bit integer number format. Developers of the present technology have devised a two-step quantization method to quantize data points representing node weights in LLMs based on manipulation of number format and applying a clamping function to the data points for conversion thereof to even a smaller number of bits. Developers have realized that implementing such a two-step quantization method may allow reducing memory consumption of LLMs during training or using thereof, for example, without loss in quality of language generation.

It should be noted that floating-point numbers (also referred to herein as “data points”) are quantized representations of real numbers in computers. For example, these numbers can represent vector embeddings or node weights of neural networks, such as those generated by the LLMs during the training thereof.

FIG. 2A shows a schematic diagram of single precision floating-point format according to an Institute of Electrical and Electronics Engineers (IEEE) 754 standard. It should be noted that each floating-point number has its own exponent which corresponds to an individual scale for each number. The developers of the present technology have devised a two-step method for quantizing the floating-point numbers. During the first phase, a given floating-point number is quantized to a fixed-point number where: (1) each group of numbers have a shared exponent or scale and (2) the sign and integer part of each individual number can be different from others.

With reference to FIG. 2B, there is schematically depicted the fixed-point format generated during the first phase of the present method, in accordance with certain non-limiting embodiments of the present technology. According to certain non-limiting embodiments of the present technology, the fixed-point format of a given data point schematically depicted in FIG. 2B can be generated as described in a co-owned United States Patent Application Publication No.: 2023/0376,769-A1, published on Nov. 23, 2023, and entitled “METHOD AND SYSTEM FOR TRAINING MACHINE LEARNING MODELS USING DYNAMIC FIXED-POINT DATA REPRESENTATION,” the content of which is incorporated herein by reference in its entirety.

In some embodiments, the shared exponent is a maximum exponent of a group of floating-point numbers. In some embodiments of the two-step quantization method, after quantizing to M-bit signed integers, a second step of clamping to lower number of bits is further performed to reduce the N number of bits, which smaller than M.

More specifically, in accordance with a first broad aspect of the present technology, there is provided a computer-implemented method for storing data points. The method comprises: receiving the plurality of data points, each data point of the plurality of data points being represented in a floating-point representation; quantizing each one of the first plurality of data points, by: executing, during a first quantization phase: converting each data point of the plurality of data points into a corresponding first data point of a plurality of first data points, each first data point being represented in a dynamic fixed-point representation; and executing, during a second quantization phase, following the first quantization phase: applying, to each first data point of the plurality of first data points a clamping function, thereby converting each first data point of the plurality of first data points into a corresponding second data point of a plurality of second data points; and storing the plurality of second points for further calculations instead of the first plurality of data points.

In some implementations of the method, each data point of the plurality of data points is represented in a floating-point representation comprising: a sign component represented as an integer, a floating-point exponent component represented as an integer, and a floating-point mantissa component represented as an integer.

In some implementations of the method, the floating-point representation is based on an Institute of Electrical and Electronics Engineers (IEEE) 754 standard.

In some implementations of the method, the plurality of first data points comprises: for each first data point, a sign component of a corresponding data point; for each first data point, a dynamic fixed-point mantissa component, and one or more shared scale components, at least two of the plurality of first data points sharing a value of a shared scale component of the one or more shared scale components.

In some implementations of the method, each data point of the plurality of data points is represented in a floating-point representation comprising: a sign component represented as an integer, a floating-point exponent component represented as an integer, and a floating-point mantissa component represented as an integer; and the converting each data point of the plurality of data points into the corresponding first data point of the plurality of first data points comprises:

generating preliminary first data points by adjusting a value of the floating-point mantissa component of each first data point based on the value of the shared scale component, each data point of the preliminary first data points having the sign component and a preliminary mantissa component, and at least two of the preliminary first data points sharing the value of the shared scale component.

In some implementations of the method, the converting further comprises rounding a value of the preliminary mantissa component of each data point of the preliminary first data points, for obtaining a desired number of bits for representing a value of the dynamic fixed-point mantissa component of the plurality of first data points.

In some implementations of the method, prior to the storing the plurality of second data points, the method further comprises calibrating each second point of the plurality of second points.

In some implementations of the method, the calibrating comprises applying an Open Pre-trained Transformers Quantization (OPTQ) algorithm.

In some implementations of the method, the calibrating comprises using a reinforcement ML model.

In some implementations of the method, the reinforcement ML model has been trained based at least in part on human-generated labels.

In some implementations of the method, the calibrating comprises using an optimization algorithm based on a loss function.

In some implementations of the method, wherein the loss function is a Mean Squared Error (MSE) loss function.

In some implementations of the method, the plurality of data points is representative of node weights of an ML model; and the further calculations are for at least one of training and using the ML model.

In some implementations of the method, each first data point and each second data point are represented in an integer format; each first data point of the plurality of first data points has M bits; and each second data point of the plurality of second data points has N bits, N being smaller than M.

In accordance with a second broad aspect of the present technology, there is provided a computer-implemented method for storing data points. The method comprises: receiving the plurality of data points, each data point of the plurality of data points being represented in a floating-point representation; quantizing each one of the first plurality of data points, by: executing, during a first quantization phase: converting each data point of the plurality of data points into a corresponding first data point of a plurality of first data points, each first data point being represented in an integer format having M bits; and executing, during a second quantization phase, following the first quantization phase: applying, to each first data point of the plurality of first data points a clamping function, thereby converting each first data point of the plurality of first data points into a corresponding second data point of a plurality of second points, each second point being represented in the integer format having N bits, N being smaller than M; and storing the plurality of second points for further calculations instead of the first plurality of data points.

In accordance with a third broad aspect of the present technology, there is provided a computing device for storing data points. The computing device comprises at least one processor and at least one non-transitory computer-readable memory storing executable instructions, which, when executed by the at least one processor, cause the computing device to: receive the plurality of data points, each data point of the plurality of data points being represented in a floating-point representation; quantize each one of the first plurality of data points, by: executing, during a first quantization phase: converting each data point of the plurality of data points into a corresponding first data point of a plurality of first data points, each first data point being represented in a dynamic fixed-point representation; and executing, during a second quantization phase, following the first quantization phase: applying, to each first data point of the plurality of first data points a clamping function, thereby converting each first data point of the plurality of first data points into a corresponding second data point of a plurality of second data points; and store the plurality of second points for further calculations instead of the first plurality of data points.

In some implementations of the computing device, each data point of the plurality of data points is represented in a floating-point representation comprising: a sign component represented as an integer, a floating-point exponent component represented as an integer, and a floating-point mantissa component represented as an integer.

In some implementations of the computing device, the plurality of first data points comprises: for each first data point, a sign component of a corresponding data point;

for each first data point, a dynamic fixed-point mantissa component, and one or more shared scale components, at least two of the plurality of first data points sharing a value of a shared scale component of the one or more shared scale components.

In some implementations of the computing device, each data point of the plurality of data points is represented in a floating-point representation comprising: a sign component represented as an integer, a floating-point exponent component represented as an integer, and a floating-point mantissa component represented as an integer; and to convert each data point of the plurality of data points into the corresponding first data point of the plurality of first data points, the at least one processor causes the computing device to: generate preliminary first data points by adjusting a value of the floating-point mantissa component of each first data point based on the value of the shared scale component, each data point of the preliminary first data points having the sign component and a preliminary mantissa component, and at least two of the preliminary first data points sharing the value of the shared scale component.

In some implementations of the computing device, to convert each data point of the plurality of data points into the corresponding first data point of the plurality of first data points, the at least one processor further causes the computing device to round a value of the preliminary mantissa component of each data point of the preliminary first data points, for obtaining a desired number of bits for representing a value of the dynamic fixed-point mantissa component of the plurality of first data points.

In the context of the present technology, “floating-point values” are numbers that used for representing real numbers in the computer. They consist of three main components notably sign, exponent and mantissa. The sign, exponent, and mantissa are integer numbers.

In the context of the present technology, the term “UNPACK floating-point values” refers a function that receives one or several floating-point values and decomposes them to sign, exponent and mantissa values.

In the context of the present technology, the term “PACK floating-point value” refers to a function that receives one or several sign, exponent and mantissa values and packs them to floating-point values.

In the context of the present technology, the term “rounding” refers to an operation of omitting leftover numbers. Because real numbers in computer have limited precision, when there are more digits than the format allows, the leftover ones are omitted. The operation is used to round up numbers.

In the context of the present technology, in accordance with a “round to nearest tie to away” algorithm, the floating-point number nearest to the infinitely precise result shall be delivered; if the two nearest floating-point numbers bracketing an unrepresentable infinitely precise result are equally near, the one with larger magnitude shall be delivered.

In the context of the present technology, in accordance with a “round to nearest tie to even” algorithm, the floating-point number nearest to the infinitely precise result shall be delivered; if the two nearest floating-point numbers bracketing an unrepresentable infinitely precise result are equally near, the one with an even least significant digit shall be delivered.

In the context of the present technology, in accordance with a “Stochastic Rounding” algorithm, rounding that shall randomly deliver the nearest larger or nearest smaller floating-point number. The randomness is user-defined functionality and usually depends to a probability density function and also the number that is supposed to be rounded.

In the context of the present specification, a “server” is a computer program that is running on appropriate hardware and is capable of receiving requests (e.g., from devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “device” is any computer hardware that is capable of running software appropriate to the relevant task at hand. Thus, some (non-limiting) examples of devices include personal computers (desktops, laptops, netbooks, etc.), smartphones, and tablets, as well as network equipment such as routers, switches, and gateways. It should be noted that a device acting as a device in the present context is not precluded from acting as a server to other devices. The use of the expression “a device” does not preclude multiple devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers. It can be said that a database is a logically ordered collection of structured data kept electronically in a computer system

In the context of the present specification, the expression “information” includes information of any nature or kind whatsoever capable of being stored in a database. Thus, information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 illustrates an example of a computing device that may be used to implement any of the methods described herein;

FIG. 2A shows a schematic diagram of single precision floating-point format according to an Institute of Electrical and Electronics Engineers (IEEE) 754 standard;

FIG. 2B schematically depicts a dynamic fixed-point format generated during a first phase of a quantization pipeline, in accordance with certain non-limiting embodiments of the present technology;

FIG. 3A depicts a schematic diagram of forward propagation of a plurality of input data points through a given machine-learning (ML) model, executed by a processor of the computing device of FIG. 1, without quantization, in accordance with certain non-limiting embodiments of the present technology;

FIG. 3B depicts a schematic diagram of a two-phase quantization pipeline of the plurality of input data points, in accordance with certain non-limiting embodiments of the present technology;

FIG. 4 depicts a schematic diagram of the first phase of the two-phase quantization pipeline of FIG. 3B, in accordance with certain non-limiting embodiments of the present technology;

FIGS. 5A and 5B depict tables illustrating an evaluation of the first phase of the two-phase quantization pipeline of FIG. 3B, in accordance with certain non-limiting embodiments of the present technology; and

FIG. 6 is a flowchart diagram of a method, executed by the processor of the computing device of FIG. 1, for storing the plurality of input data points, in accordance with certain non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general-purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

With these fundamentals in place, we will now consider some non-limiting examples to illustrate various implementations of aspects of the present technology.

### Computing Device

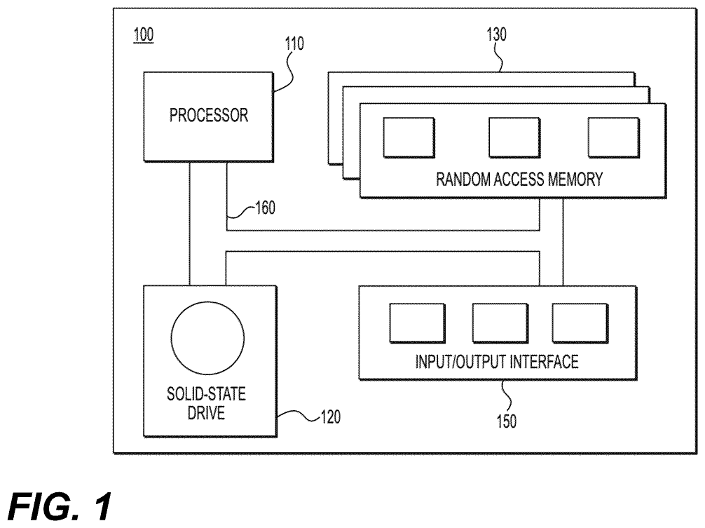

FIG. 1 illustrates a diagram of a computing device 100 in accordance with an embodiment of the present technology is shown. In some embodiments, the computing device 100 may be implemented by any of a conventional personal computer, a computer dedicated to operating and/or monitoring systems relating to a data center, a controller and/or an electronic device (such as, but not limited to, a mobile device, a tablet device, a server, a controller unit, a control device, a monitoring device etc.) and/or any combination thereof appropriate to the relevant task at hand. In some embodiments, the computing device 100 comprises various hardware components including one or more single or multi-core processors collectively represented by a processor 110, a solid-state drive 120, a random-access memory 130 and an input/output interface 150.

In some embodiments, the computing device 100 may also be a sub-system of one of the above-listed systems. In some other embodiments, the computing device 100 may be an “off the shelf” generic computer system. In some embodiments, the computing device 100 may also be distributed amongst multiple systems. The computing device 100 may also be specifically dedicated to the implementation of the present technology. As a person in the art of the present technology may appreciate, multiple variations as to how the computing device 100 is implemented may be envisioned without departing from the scope of the present technology.

Communication between the various components of the computing device 100 may be enabled by one or more internal and/or external buses 160 (e.g., a PCI bus, universal serial bus, IEEE 1394 “Firewire” bus, SCSI bus, Serial-ATA bus, ARINC bus, etc.), to which the various hardware components are electronically coupled.

The input/output interface 150 may allow enabling networking capabilities such as wire or wireless access. As an example, the input/output interface 150 may comprise a networking interface such as, but not limited to, a network port, a network socket, a network interface controller and the like. Multiple examples of how the networking interface may be implemented will become apparent to the person skilled in the art of the present technology. For example, but without being limitative, the networking interface may implement specific physical layer and data link layer standard such as Ethernet, Fibre Channel, Wi-Fi or Token Ring. The specific physical layer and the data link layer may provide a base for a full network protocol stack, allowing communication among small groups of computers on the same local area network (LAN) and large-scale network communications through routable protocols, such as Internet Protocol (IP).

According to implementations of the present technology, the solid-state drive 120 stores program instructions suitable for being loaded into the random-access memory 130 and executed by the processor 110 for executing operating data centers based on a generated machine learning pipeline. For example, the program instructions may be part of a library or an application.

In some embodiments of the present technology, the computing device 100 may be implemented as part of a cloud computing device. Broadly, a cloud computing device is a type of computing that relies on a network of remote servers hosted on the internet, for example, to store, manage, and process data, rather than a local server or personal computer. This type of computing allows users to access data and applications from remote locations, and provides a scalable, flexible, and cost-effective solution for data storage and computing. Cloud computing devices can be divided into three main categories: Infrastructure as a Service (IaaS), Platform as a Service (PaaS), and Software as a Service (SaaS). In an IaaS environment, users can rent virtual servers, storage, and other computing resources from a third-party provider, for example. In a PaaS environment, users have access to a platform for developing, running, and managing applications without having to manage the underlying infrastructure. In a SaaS environment, users can access pre-built software applications that are hosted by a third-party provider, for example. In summary, cloud computing devices offer a range of benefits, including cost savings, scalability, increased agility, and the ability to quickly deploy and manage applications.

### Two-Phase Quantization Pipeline

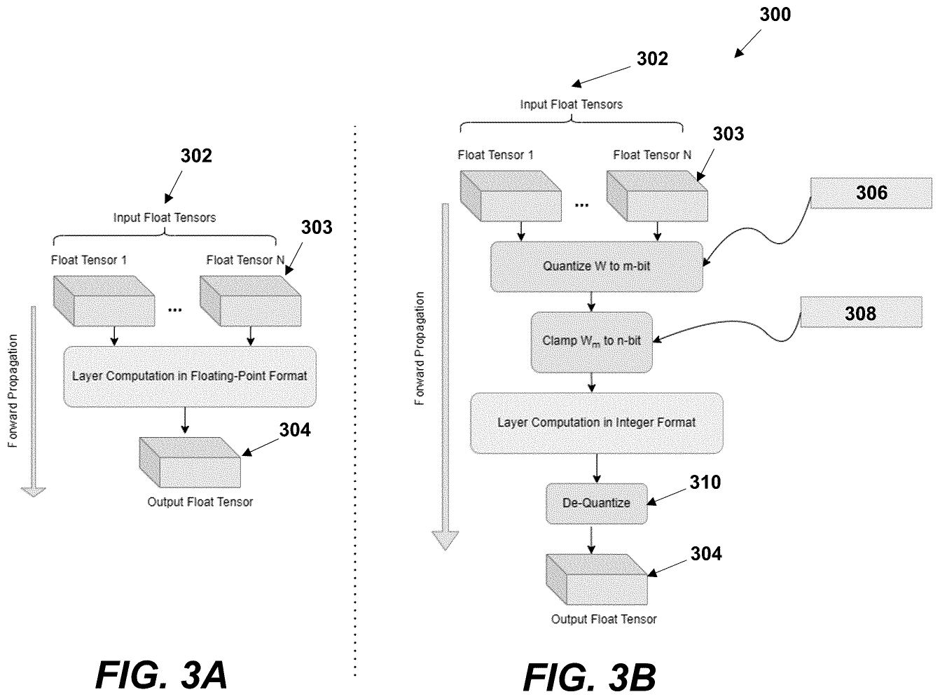

With reference to FIG. 3A, there is depicted a schematic diagram of forward propagation of a plurality of input data points 302 through a given machine-learning (ML) model (not separately labelled) without quantization, in accordance with certain non-limiting embodiments of the present technology.

According to certain non-limiting embodiments of the present technology, the given ML model can be implemented as deep neural network having a plurality of layers, including, without limitation, a convolutional neural network (CNN), a recurrent neural network (RNN), or a Transformer-based neural network, such as a Generative Pre-training Transformer (GPT) or Bidirectional Encoder Representations from Transformers (BERT). Accordingly, the given ML model can be trained using various training approaches, including supervised, unsupervised, or reinforcement learning. In some non-limiting embodiments of the present technology, the given ML model can comprise a language ML model, such as an OPT large language ML model. The given ML model can be executed, for example, by the processor 110 of the computing device 100 described above.

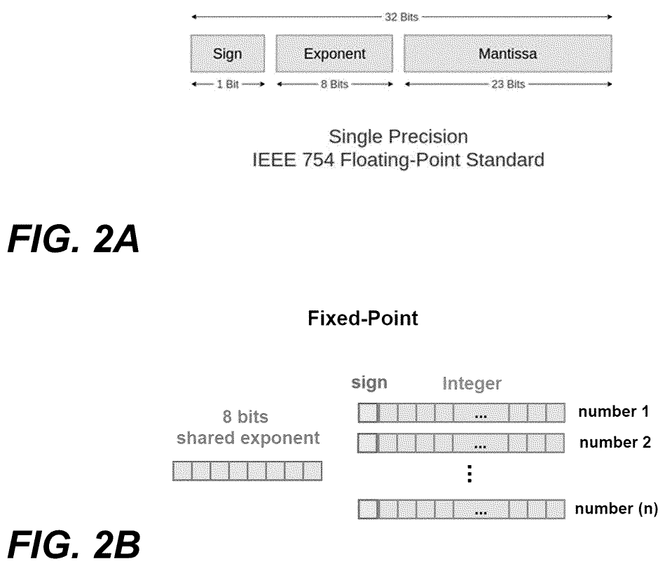

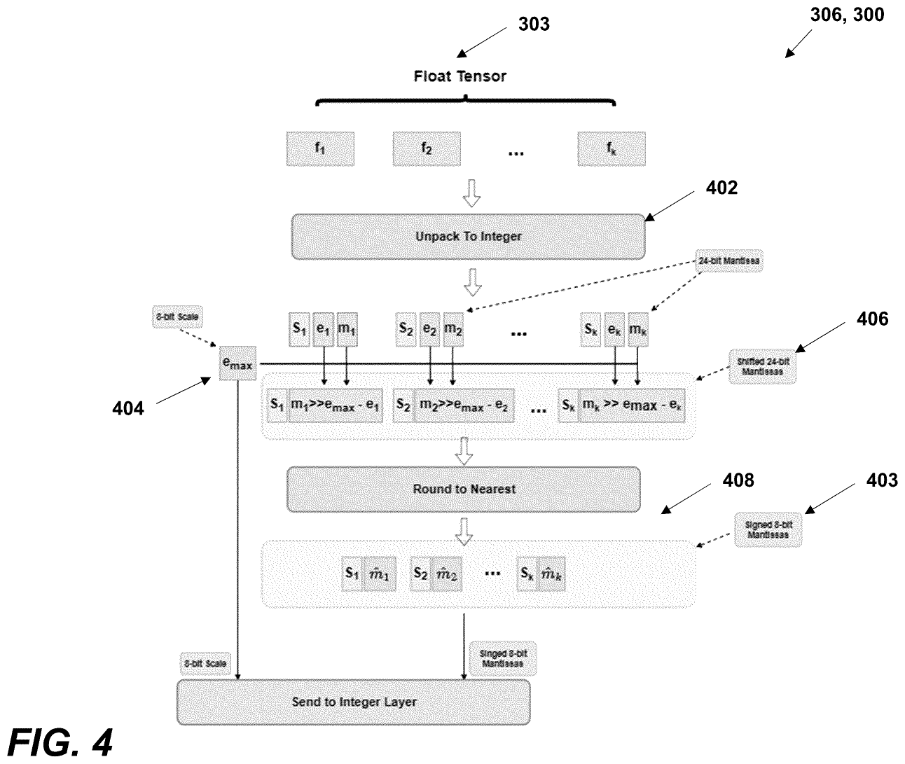

According to certain non-limiting embodiments of the present technology, the plurality of input data points 302 can be representative of one of training data or in-use data of the given ML model. In other words, in those embodiments where the given ML model is implemented as a deep neural network, the plurality of input data points 302 can be representative of current node weights of the given ML model. As it can be appreciated from FIG. 4A, a given input data point 303 can be represented by a floating-point tensor, each value of which can correspond to the IEEE 754 standard mentioned above with reference to FIG. 2A.

By the forward-propagation of the plurality of input data points 302, the given ML model can be configured to generate output data points 304, each one of which can also be represented in the format described in FIG. 2A.

However, using floating-point values for calculations within the given ML model may require a considerable amount of computational resources of the processor 110 and of other components of the computing device 100.

With reference to FIG. 3B, there is depicted a schematic diagram of a two-phase quantization pipeline 300 of the plurality of input data points 302, in accordance with certain non-limiting embodiments of the present technology.

Broadly, according to certain non-limiting embodiments of the present technology, the two-phase quantization pipeline 300 comprises: (i) a first phase 306, during which the processor 110 can be configured to convert the given input data point 303 of the plurality of input data points 302 into a respective first data point 403 (depicted in FIG. 4) of a plurality of first data points (not depicted); and (ii) a second phase 308, during which the processor 110 can be configured to convert the respective first data point 403 into a respective second data point (not depicted) of a plurality of second data points. According to certain non-limiting embodiments of the present technology, the respective first and second data points can be represented in an integer format, having M and N bits respectively, where N is smaller than M.

After the consecutive application of the first and second phases 306, 308 of quantization and forward propagation of the plurality of second data points through the given ML model, in some non-limiting embodiments of the present technology, the processor 110 can be configured to apply a de-quantization operation 310 to the outputs of the given ML model to convert data points of the integer format having N bits back to the floating-point format of FIG. 2A, thereby generating the output data points 304.

Each phase of the two-phase quantization pipeline 300 will now be described in greater detail.

### First Phase

With reference to FIG. 4, there is depicted a schematic diagram of the first phase 306 of the two-phase quantization pipeline 300, in accordance with certain non-limiting embodiments of the present technology. According to certain non-limiting embodiments of the present technology, during the first phase 306, the processor 110 can be configured to convert the given input data point 303 into the respective first data point 403 of the plurality first data points of the integer format.

As best shown in FIG. 4, according to certain non-limiting embodiments of the present technology, the processor 110 can be configured to receive the given inputs data point 303 represented by a floating-point tensor of m×n floating-point numbers F_{m×n}. Further, the processor 110 can be configured to convert these numbers to the corresponding integer sign, exponent and mantissas using an unpack to integer function 402. As will become apparent from the description provided herein below, by using the unpack to integer function 402, the processor 110 can be configured to generate respective dynamic-fixed representations of each value of the floating-point tensor of the given input data point 303. More details on implementations of this function can be found in the co-owned Patent Application referenced above.

Broadly speaking, after using the unpack to integer function 402, the processor 110 can be configured to further: (i) determine a maximum exponent 404 as a shared scale (also referred to herein as a “shared scale component”) for values of the floating-point tensor of the given input data point 303; and (ii) use the respective shared scale components to determine, for each floating-point mantissa, a dynamic fixed-point mantissa.

According to certain non-limiting embodiments of the present technology, the processor 110 can be configured to apply the unpack to integer function 402 to the given input data point 303 in one of the following manners:
Per-tensor. In this example, the processor 110 can be configured to determine the maximum exponent 404 as being a maximum exponent in the whole floating-point tensor. That is, in these embodiments, the maximum exponent 404 will be representative of a single shared scale component in the floating-point tensor.
Per-column. In this example, the processor 110 can be configured to identify the maximum exponent 404 for each column of the floating-point tensor. In other words, the processor 110 can be configured to determine a respective shared scale component for each column of the tensor. That is, there will be n shared scales for the tensor.
Per-group. In this example, the processor 110 can be configured to determine, in each column, a group of the values having a groupsize<m, and determine the maximum exponent 404 in each group. In the other words, the processor 110 can be configured to determine

$$⌈ \frac{m}{groupsize} \times n ⌉$$

number of shared scale components in the floating-point tensor of the given data point 303.

It should be expressly understood that other manners of applying the unpack to integer function 402 to the values of the floating-point tensor are envisioned. For example, the processor 110 can be configured to apply the unpack to integer function 402 to a group of values of an arbitrary dimension within the floating-point tensor determined based on a trade-off between the speed and desired accuracy of calculations.

Further, according to certain non-limiting embodiments of the present technology, the processor 110 can be configured to convert the given input data point 303 into the respective first data point 403 by adjusting a value of the floating-point mantissa of each floating-point value of the floating-point tensor of the given input data point 303 based on the value of the respective shared scale component.

More specifically, after determining, depending on the particular embodiments, in a given group, column, or in the whole floating-point tensor, the respective shared scale component, according to certain non-limiting embodiments of the present technology, the processor 110 can be configured to apply, to each floating-point mantissa, a shifting procedure 406 to shift each floating-point mantissa to a respective deviation value of a respective individual (original) exponent from the respective shared scale component. By doing so, the processor 110 can be configured to generate a respective dynamic fixed-point mantissa component of each floating-point value of the floating-point tensor of the given input data point 303.

It should be noted that, because each floating-point mantissa in the IEEE 754 standard has 24 bits (including the hidden bit in single precision floating-point), in some non-limiting embodiments of the present technology, the processor 110 can be configured to apply a rounding procedure 408 to round the shifted mantissas of the values of the respective first data point 403 to a desired number of bits, M. For example, in order to quantize to 8-bit (that is, if M is 8) integers, the processor 110 can be configured to round the shifted 24-bit mantissa of the values of the respective first data point 403 to the nearest 7-bit mantissa (plus an additional bit indicative of a sign of a given value of the respective first data point 403). According to certain non-limiting embodiments of the present technology, the rounding procedure 408 can include, without limitation, at least one of the round to nearest tie to away algorithm, the round to nearest tie to even algorithm, and the Stochastic Rounding algorithm defined above.

Further, the processor 110 can be configured to use the shared scale components and dynamic fixed-point mantissas of the respective first data point 403 generated during the first phase 306 in the computations of the desired layer of the given ML model, which may help reduce memory consumption of the computing device 100 compared to using the given input data point 303 prior to the quantization.

### Second Phase

With back reference to FIG. 3B, according to certain non-limiting embodiments of the present technology, after generating, during the first phase 306, the plurality of first data points, values of which have the dynamic fixed-point representations, the processor 110 can be configured to execute the second phase 308 of the quantization pipeline 300. By doing so, the processor 110 can be configured to generate, using the respective first data point 403, a respective second data point of the plurality of second data points.

To that end, according to certain non-limiting embodiments of the present technology, the processor 110 can be configured to apply, to the dynamic fixed-point mantissas of the respective first data point 403 having M bits (such as 8, for example), a clamping function. By doing so, the processor 110 can be configured to reduce the number of bits in a given dynamic fixed-point mantissa to N (which is smaller than M). For example, if the M is 8, N can be 4.

By way of example, and not as a limitation, let it be assumed that a given value of the respective first data point 403 has M=8 bits, that is, takes values between −128 to 127. Let it further be assumed that a desired number of bits for each value of the respective second data point is N=4-bit, which takes values between −8 to 7. Thus, the processor 110 can be configured to use the clamping function to reduce the number of bits from M to N as follows: if the value of the given value of the respective first data point 403 is greater or equal to 7, for example 16, the processor 110 is configured to replace with 7 (maximum in the 4-bit integer format). In another example, if the given value is less than or equal to −8, for example −16, the processor 110 is configured to clamp it to −8. In other words, by using the clamping function, the processor 110 is configured to retain values of the respective first data point 403 within a predetermined range corresponding to the desired data format, that is, in the present example, N-bit integer data format.

Thus, by applying the clamping function to each value of the respective first data point 403, the processor 110 can be configured to generate the respective second data point of the plurality of second data points, which can be used in computations within the given ML model. For example, the plurality of second data points having values of the integer format having N bits each can further be stored in the solid-state drive 120 of the computing device 100, for example, for inference (or deployment) of the given ML model. As it can be appreciated, for storing the plurality of second data points, it may be required less space than for storing the plurality of input data points 302.

Thus, certain non-limiting embodiments of the present methods and systems may allow considerably reduce the consumption of the computational resources when operating with floating-point numbers without significant loss in accuracy.

In additional non-limiting embodiments of the present technology, the processor 110 can be configured to calibrate values of the respective second data point. According to various non-limiting embodiments of the present technology, to calibrate the values of the respective second data point, the processor 110 can be configured to apply at least one of: an Open Pre-trained Transformers Quantization (OPTQ) algorithm; a reinforcement ML model having been trained for calibrating data points based at least in part on human-generated labels; and an optimization method based on a loss function, such as a Mean Squared Error (MSE) loss function. By calibrating the values of the respective second data point, the processor 100 can be configured to increase accuracy of calculations using the plurality of second data points.

### Experiments and Results

The present quantization pipeline 300 has been used to quantize an OPT 1.3B model trained with reinforcement learning from human feedback for further analysis of quality and accuracy of text generation.

First, the node weights of the model have been loaded and quantized without using any additional data. In this setting, there was used the half precision model (fp16) as a baseline.

For evaluation of the quantization pipeline 300, there were used an edit distance and reward model. Edit distance is a metric that shows how dissimilar two strings are, and measures the minimum number of operations required to transform one string into the other. The reward model has been determined as being an OPT 350M model trained to simulate human evaluation based on existing human feedback datasets.

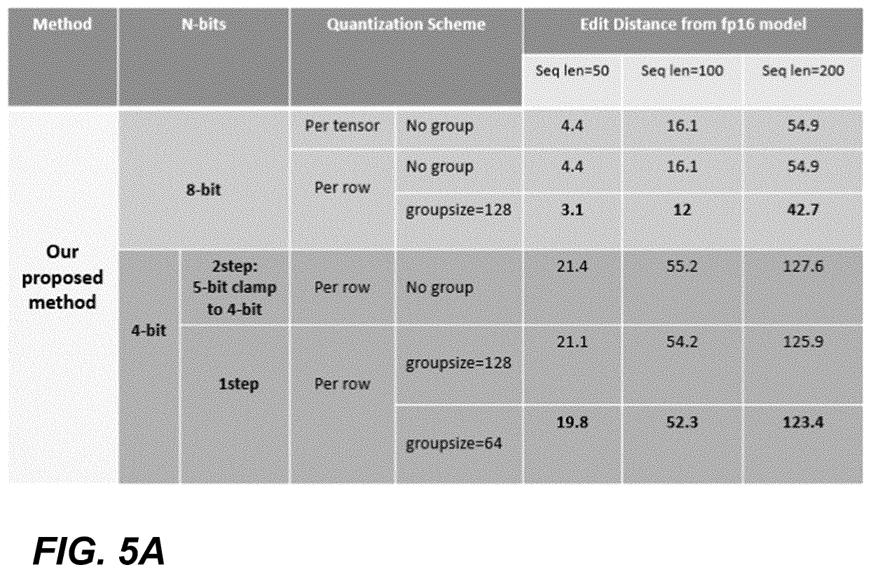

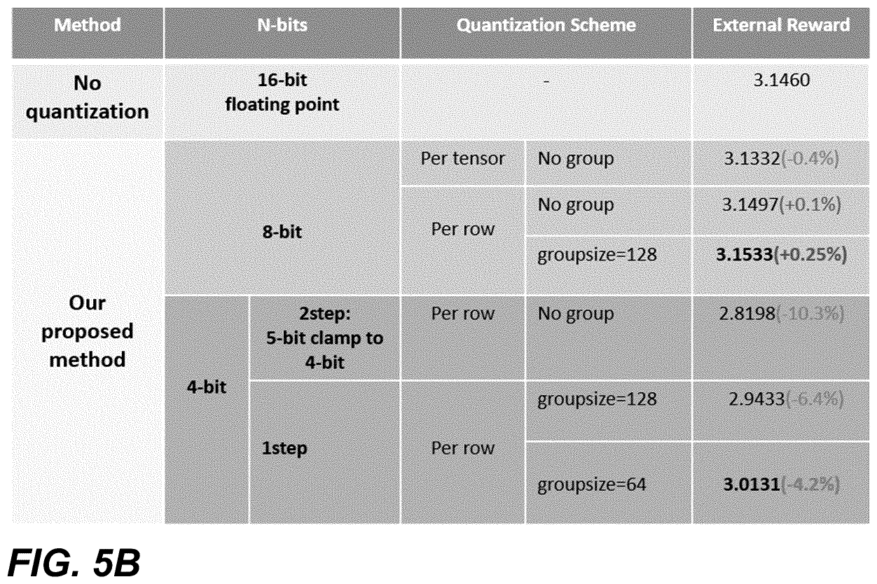

With reference to FIGS. 5A and 5B, there are depicted tables showing an evaluation of the edit distance and reward model for 8-bit and 4-bit quantization tested on a TruthfulQA dataset. It can be observed that group-wise quantization and column-wise quantization have better quality in text generation compared to per-tensor quantization, however these schemes have less memory saving. Moreover, when moving to 4-bit quantization, 1-step quantization to 4-bit generates poorer-quality sentences while by performing two step quantization based on quantizing to 5-bit mantissas and then clamping dynamic fixed-point mantissas to 4-bit integer values, i.e., {−8, −7, . . . , 7}, as provided by the present method, the quantized model generates acceptable sentences based on the aforementioned metrics. Thus, it may be concluded that the present methods and systems allow quantizing floating-point numbers to lower bits preserving the desired accuracy.

### Computer-Implemented Method

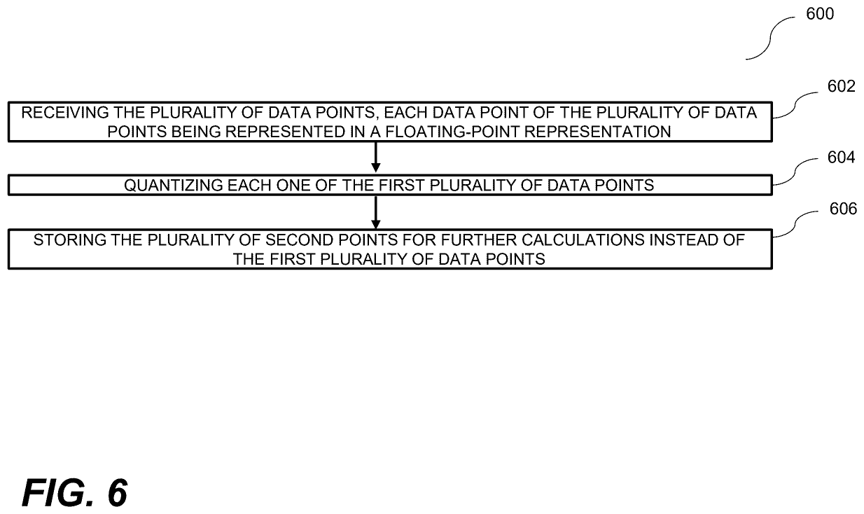

Given the architecture and examples described above, it is now possible to execute a method of storing the data points, such as the plurality of input data points 302 mentioned above. With reference to FIG. 6, there is depicted a scheme-block representation of a method 600. The method 600 can be executed by the processor 110 of the computing device 100.

Step 602: Receiving the Plurality of Data Points, Each Data Point of the Plurality of Data Points being Represented in a Floating-Point Representation

The method 600 commences at step 602 with the processor 110 being configured to receive the plurality of input data points 302.

According to certain non-limiting embodiments of the present technology, the plurality of input data points 302 can be representative of one of training data or in-use data of the given ML model. In other words, in those embodiments where the given ML model is implemented as a deep neural network, the plurality of input data points 302 can be representative of current node weights of the given ML model. As mentioned above with reference to FIG. 3A, the given input data point 303 can be represented by a floating-point tensor, each value of which can correspond to the IEEE 754 standard described above with reference to FIG. 2A.

The method 600 hence advances to step 604.

### Step 604: Quantizing Each One of the First Plurality of Data Points.

At step 604, according to certain non-limiting embodiments of the present technology, the processor 110 can be configured to quantize each one if the plurality of input data points 302 for further computations within the given ML model. To do so, according to certain non-limiting embodiments of the present technology, the processor 110 can be configured to apply to the plurality of input data points 302 the two-phase quantization pipeline 300 described above with reference to FIG. 3B.

As explained in detail above with reference to FIGS. 3B and 4, the two-phase quantization pipeline 300 comprises: (i) the first phase 306, during which the processor 110 can be configured to convert the given input data point 303 of the plurality of input data points 302 into the respective first data point 403 of the plurality of first data points; and (ii) the second phase 308, during which the processor 110 can be configured to convert the respective first data point 403 into the respective second data point (not depicted) of the plurality of second data points. According to certain non-limiting embodiments of the present technology, the respective first and second data points can be represented in an integer format, having M and N bits respectively, where N is smaller than M.

More specifically, during the first phase 306, using the unpack to integer function 402, the processor 110 can be configured to generate respective dynamic-fixed representations of each value of the floating-point tensor of the given input data point 303.

Further, during the second phase 308 of the two-phase quantization pipeline 300, the processor 110 can be configured to apply, to the dynamic fixed-point mantissas of the respective first data point 403 having M bits (such as 8, for example), the clamping function, thereby reducing the number of bits to N, which can be, for example, 4. By doing so, the processor 110 can be configured to generate the respective second data point of the plurality of second data points, which can be used in computations within the given ML model.

The method 600 hence advances to step 606.

### Step 606: Storing the Plurality of Second Points for Further Calculations Instead of the First Plurality of Data Points

At step 606, according to certain non-limiting embodiments of the present technology, the processor 110 can be configured to store the plurality of second data points having values of the integer format having N bits each, for example, in the solid-state drive 120 of the computing device 100. Further, the plurality of second data points can be used, for example, for inference (or deployment) of the given ML model. As it can be appreciated, for storing the plurality of second data points, it may be required less space than for storing the plurality of input data points 302.

Thus, certain non-limiting embodiments of the present methods and systems may allow considerably reduce the consumption of the computational resources when operating with floating-point numbers without significant loss in accuracy.

The method 600 thus terminates.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A computer-implemented method for storing data points comprising:
receiving the plurality of data points,
each data point of the plurality of data points being represented in a floating-point representation;
quantizing each one of the first plurality of data points, by:
executing, during a first quantization phase:
converting each data point of the plurality of data points into a corresponding first data point of a plurality of first data points, each first data point being represented in a dynamic fixed-point representation; and
executing, during a second quantization phase, following the first quantization phase:
applying, to each first data point of the plurality of first data points a clamping function, thereby converting each first data point of the plurality of first data points into a corresponding second data point of a plurality of second data points; and
storing the plurality of second points for further calculations instead of the first plurality of data points.

2. The method of claim 1, wherein each data point of the plurality of data points is represented in a floating-point representation comprising:
a sign component represented as an integer,
a floating-point exponent component represented as an integer, and
a floating-point mantissa component represented as an integer.

3. The method of claim 2, wherein the floating-point representation is based on an Institute of Electrical and Electronics Engineers (IEEE) 754 standard.

4. The method of claim 1, wherein the plurality of first data points comprises:
for each first data point, a sign component of a corresponding data point;
for each first data point, a dynamic fixed-point mantissa component, and
one or more shared scale components, at least two of the plurality of first data points sharing a value of a shared scale component of the one or more shared scale components.

5. The method of claim 1, wherein:
each data point of the plurality of data points is represented in a floating-point representation comprising:
a sign component represented as an integer,
a floating-point exponent component represented as an integer, and
a floating-point mantissa component represented as an integer; and
the converting each data point of the plurality of data points into the corresponding first data point of the plurality of first data points comprises:
generating preliminary first data points by adjusting a value of the floating-point mantissa component of each first data point based on the value of the shared scale component, each data point of the preliminary first data points having the sign component and a preliminary mantissa component, and at least two of the preliminary first data points sharing the value of the shared scale component.

6. The method of claim 5, wherein the converting further comprises rounding a value of the preliminary mantissa component of each data point of the preliminary first data points, for obtaining a desired number of bits for representing a value of the dynamic fixed-point mantissa component of the plurality of first data points.

7. The method of claim 1, wherein prior to the storing the plurality of second data points, the method further comprises calibrating each second point of the plurality of second points.

8. The method of claim 7, wherein the calibrating comprises applying an Open Pre-trained Transformers Quantization (OPTQ) algorithm.

9. The method of claim 7, wherein the calibrating comprises using a reinforcement ML model.

10. The method of claim 9, wherein the reinforcement ML model has been trained based at least in part on human-generated labels.

11. The method of claim 7, wherein the calibrating comprises using an optimization algorithm based on a loss function.

12. The method of claim 11, wherein the loss function is a Mean Squared Error (MSE) loss function.

13. The method of claim 1, wherein:
the plurality of data points is representative of node weights of an ML model; and
the further calculations are for at least one of training and using the ML model.

14. The method of claim 1, wherein:
each first data point and each second data point are represented in an integer format;
each first data point of the plurality of first data points has M bits; and
each second data point of the plurality of second data points has N bits, N being smaller than M.

15. A computer-implemented method for storing data points comprising:
receiving the plurality of data points,
each data point of the plurality of data points being represented in a floating-point representation;
quantizing each one of the first plurality of data points, by:
executing, during a first quantization phase:
converting each data point of the plurality of data points into a corresponding first data point of a plurality of first data points, each first data point being represented in an integer format having M bits; and
executing, during a second quantization phase, following the first quantization phase:
applying, to each first data point of the plurality of first data points a clamping function, thereby converting each first data point of the plurality of first data points into a corresponding second data point of a plurality of second points, each second point being represented in the integer format having N bits,
N being smaller than M; and
storing the plurality of second points for further calculations instead of the first plurality of data points.

16. A computing device for storing data points, the computing device comprising at least one processor and at least one non-transitory computer-readable memory storing executable instructions, which, when executed by the at least one processor, cause the computing device to:
receive the plurality of data points,
each data point of the plurality of data points being represented in a floating-point representation;
quantize each one of the first plurality of data points, by:
executing, during a first quantization phase:
converting each data point of the plurality of data points into a corresponding first data point of a plurality of first data points, each first data point being represented in a dynamic fixed-point representation; and
executing, during a second quantization phase, following the first quantization phase:
applying, to each first data point of the plurality of first data points a clamping function, thereby converting each first data point of the plurality of first data points into a corresponding second data point of a plurality of second data points; and
store the plurality of second points for further calculations instead of the first plurality of data points.

17. The computing device of claim 16, wherein each data point of the plurality of data points is represented in a floating-point representation comprising:
a sign component represented as an integer,
a floating-point exponent component represented as an integer, and
a floating-point mantissa component represented as an integer.

18. The computing device of claim 16, wherein the plurality of first data points comprises:
for each first data point, a sign component of a corresponding data point;
for each first data point, a dynamic fixed-point mantissa component, and
one or more shared scale components, at least two of the plurality of first data points sharing a value of a shared scale component of the one or more shared scale components.

19. The method of claim 16, wherein:
each data point of the plurality of data points is represented in a floating-point representation comprising:
a sign component represented as an integer,
a floating-point exponent component represented as an integer, and
a floating-point mantissa component represented as an integer; and
to convert each data point of the plurality of data points into the corresponding first data point of the plurality of first data points, the at least one processor causes the computing device to:
generate preliminary first data points by adjusting a value of the floating-point mantissa component of each first data point based on the value of the shared scale component, each data point of the preliminary first data points having the sign component and a preliminary mantissa component, and at least two of the preliminary first data points sharing the value of the shared scale component.

20. The computing device of claim 19, wherein to convert each data point of the plurality of data points into the corresponding first data point of the plurality of first data points, the at least one processor further causes the computing device to round a value of the preliminary mantissa component of each data point of the preliminary first data points, for obtaining a desired number of bits for representing a value of the dynamic fixed-point mantissa component of the plurality of first data points.
